(19) United States
(12) Patent Application Publication
(10) Pub. No.: US 2024/0062257 A1
(43) Pub. Date: Feb. 22, 2024

(54) PARKING MANAGEMENT APPARATUS, PARKING MANAGEMENT SYSTEM, PARKING MANAGEMENT METHOD, AND NON-TRANSITORY COMPUTER-READABLE MEDIUM

(71) Applicant: NEC Corporation, Minato-ku, Tokyo (JP)

(72) Inventors: Kei YANAGISAWA, Tokyo (JP); Hiroaki Aminaka, Tokyo (JP); Kosei Kobayashi, Tokyo (JP); Kazuki Ogata, Tokyo (JP); Tetsuro Hasegawa, Tokyo (JP)

(73) Assignee: NEC Corporation, Minato-ku, Tokyo (JP)

(21) Appl. No.: 18/267,526

(22) PCT Filed: Mar. 23, 2021
(86) PCT No.: PCT/JP2021/011943

§ 371 Date: Jun. 15, 2023

(51) Int. Cl. G06Q 30/0283; G08G 1/01; G08G 1/04

(52) U.S. Cl. CPC G06Q 30/0284; G08G 1/0137; G08G 1/04; G08G 1/145

(57) ABSTRACT

An object of the present disclosure is to provide a parking management apparatus and the like that appropriately determine a fee or a free parking period of a parking lot according to a congestion condition in an external vicinity of the parking lot. The parking management apparatus according to the present disclosure may include: an external condition measuring unit that measures a congestion condition in an external vicinity of a parking lot, based on an image acquired from an imaging unit; and a determining unit that determines a fee or a free parking period of the parking lot, based on a measured congestion condition in the external vicinity of the parking lot.

### TECHNICAL FIELD

The present disclosure relates to a parking management apparatus, a parking management system, a parking management method, and a program.

### BACKGROUND ART

Patent Literature 1 discloses a parking lot management system that calculates a set fee, based on a calculated vacancy rate. Patent Literature 2 discloses a fee variation system that determines a current fee, based on both a utilization rate of a property such as a parking lot or a karaoke box and a variable fee that increases as the utilization rate increases.

### CITATION LIST

### Patent Literature

[Patent Literature 1] Japanese Unexamined Patent Application Publication No. 2006-171886

[Patent Literature 2] Japanese Unexamined Patent Application Publication No. 2002-056420

### SUMMARY OF INVENTION

### Technical Problem

However, in Patent Literatures 1 and 2, it is not possible to determine a fee of a parking lot according to an external condition of the parking lot. Therefore, when a road around the parking lot is congested, it is not possible to determine the fee of the parking lot with intention of suppressing such a congestion condition.

One of objects of the present disclosure is to provide a parking management apparatus, a parking management system, a parking management method, and a program that are able to appropriately determine a fee of a parking lot according to a congestion condition in an external vicinity of the parking lot.

### Solution to Problem

A parking management apparatus according to a first aspect of the present disclosure includes:
an external condition measuring unit configured to measure a congestion condition in an external vicinity of a parking lot, based on an image acquired from an imaging unit; and;
a determining unit configured to determine a fee or a free parking period of the parking lot, based on a measured congestion condition in the external vicinity of the parking lot.

A parking management system according to a second aspect of the present disclosure includes:
an external condition measuring unit configured to measure a congestion condition in an external vicinity of a parking lot, based on an image acquired from an imaging unit; and
a determining unit configured to determine a fee or a free parking period of the parking lot, based on a measured congestion condition in the external vicinity of the parking lot.

A parking management method according to a third aspect of the present disclosure includes:
measuring a congestion condition in an external vicinity of a parking lot, based on an image acquired from an imaging unit; and
determining a fee or a free parking period of the parking lot, based on a measured congestion condition in the external vicinity of the parking lot.

A program or a recording medium storing the program according to a fourth aspect of the present disclosure causes a computer to execute:
processing of measuring a congestion condition in an external vicinity of a parking lot, based on an image acquired from an imaging unit; and
processing of determining a fee or a free parking period of the parking lot, based on a measured congestion condition in the external vicinity of the parking lot.

### Advantageous Effects of Invention

According to the present disclosure, a fee or a free parking period of a parking lot can be determined appropriately according to a congestion condition in an external vicinity of the parking lot.

### BRIEF DESCRIPTION OF DRAWINGS

FIG. 1 is a block diagram illustrating a configuration of a parking management apparatus according to a first example embodiment;

FIG. 2 is a flowchart illustrating a parking management method according to the first example embodiment;

FIG. 3 is a block diagram illustrating a configuration of a parking management apparatus according to a second example embodiment;

FIG. 4 is a flowchart illustrating a parking management method according to the second example embodiment;

FIG. 5 is a diagram illustrating an exemplary overall configuration of a parking management system according to a third example embodiment;

FIG. 6 is a block diagram illustrating a configuration of the parking management system according to the third example embodiment;

FIG. 7 is a block diagram illustrating a configuration of the parking management apparatus according to the third example embodiment;

FIG. 8 is a flowchart illustrating a parking management method according to the third example embodiment; and

FIG. 9 is a block diagram illustrating a configuration example of hardware of a parking management apparatus and the like.

### EXAMPLE EMBODIMENT

### First Example Embodiment

Hereinafter, example embodiments of the present invention will be described with reference to the drawings.

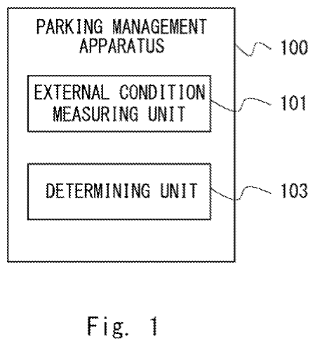

FIG. 1 is a block diagram illustrating a configuration of a parking management apparatus according to a first example embodiment.

The present disclosure relates generally to dynamic pricing of a parking lot. A parking management apparatus 100 may be achieved by a computer including a processor and a memory, and may be used to dynamically adjust a parking fee or a free parking period according to a congestion condition in a vicinity of the parking lot. The parking management apparatus 100 may be used to provide a service of providing a user looking for a parking lot with a location and a fee of a parking lot. Specifically, as illustrated in FIG. 1, the parking management apparatus 100 includes an external condition measuring unit 101 and a determining unit 103.

The external condition measuring unit 101 measures a congestion condition in an external vicinity of a parking lot, based on an image acquired from an imaging unit. Herein, the term “external vicinity of a parking lot” refers to a road network surrounding the parking lot. In some example embodiments, an external vicinity of a parking lot may refer to a road network between one parking lot available to a general user and another parking lot available to the general user and nearest to the one parking lot. The external vicinity of the parking lot may not necessarily be the entire perimeter of the parking lot, and may refer only to a road facing an entrance or exit of the parking lot. The imaging unit is achieved by an illumination unit such as a white LED, an imaging optical system including an imaging lens, and an image sensor element (complementary metal oxide semiconductor (CMOS) imager, charge-coupled device (CCD), or the like), irradiates the external vicinity of the parking lot with a white LED or the like, and performs imaging.

The determining unit 103 adjusts a parking fee or a free parking period, based on the measured congestion condition in the external vicinity of the parking lot. For example, the fee of the parking lot may be adjusted to be higher as a degree of congestion in the external vicinity of the parking lot increases. The adjustment may be made in such a way as to shorten the free parking period as the degree of congestion in the external vicinity of the parking lot increases.

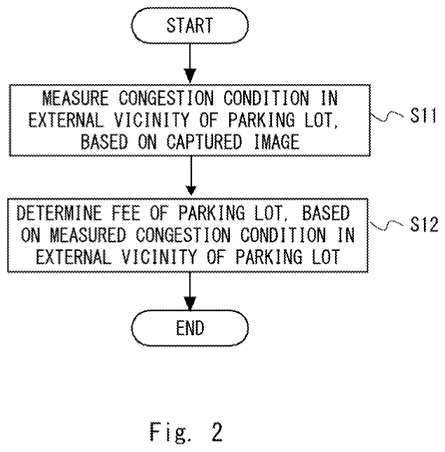

FIG. 2 is a flowchart illustrating a parking management method according to the first example embodiment.

The external condition measuring unit 101 measures a congestion condition in an external vicinity of a parking lot, based on an image acquired from the imaging unit (step S11). The determining unit 103 adjusts a fee or a free parking period of the parking lot, based on the measured congestion condition in the external vicinity of the parking lot (step S12).

According to the first example embodiment described above, it is possible to appropriately adjust the fee or the free parking period of the parking lot according to the congestion condition in the external vicinity of the parking lot.

### Second Example Embodiment

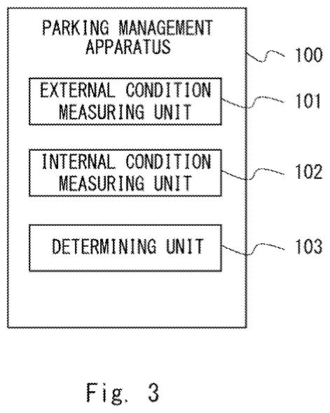

FIG. 3 is a block diagram illustrating a configuration of a parking management apparatus according to a second embodiment.

A parking management apparatus 100 may be achieved by a computer including a processor and a memory, and may be used to dynamically adjust a fee of a parking lot according to a congestion condition around the parking lot. The parking management apparatus 100 may be used to provide a service of providing a user looking for a parking lot with a location and a fee of a parking lot. Specifically, as illustrated in FIG. 3, the parking management apparatus 100 includes an external condition measuring unit 101, an internal condition measuring unit 102, and a determining unit 103. In the present example embodiment, the internal condition measuring unit 102 is added as compared with the first example embodiment.

The external condition measuring unit 101 measures the congestion condition around an external vicinity of a parking lot, based on an image captured by an imaging unit. The external condition measuring unit 101 can also determine whether a traffic jam is due to waiting to enter the parking lot or due to another cause, based on the captured image. For example, when a winker of a vehicle is directed toward the parking lot in an image captured by a camera, it can be determined that a traffic jam is due to waiting to enter the parking lot.

The internal condition measuring unit 102 measures a congestion condition inside the parking lot. The congestion condition is information indicating an occupancy rate of the parking lot, vacancy information, and the like. An internal condition measuring unit 101 acquires, for example, vacancy information (or occupancy information) of a parking lot in an urban area, a tourist site, or the like. The internal condition measuring unit 101 can acquire the vacancy information (or the occupancy information), based on an image captured by the imaging unit such as a camera. In addition, the internal condition measuring unit 101 may acquire the vacancy information (or the occupancy information) in conjunction with an openable/closable gate attached to the parking lot. Further, the internal condition measuring unit 101 may acquire the vacancy information (or the occupancy information) in conjunction with various sensors (for example, sensors attached to a flap plate). Note that, these are merely examples, and the vacancy information (or the occupancy information) may be acquired by using another suitable method.

The determining unit 103 determines a fee or a free parking period of the parking lot, based on the measured congestion condition outside the parking lot and the congestion condition inside the parking lot. The determining unit 103 according to the present example embodiment can determine the fee or the free parking period of the parking lot more flexibly and appropriately based on not only the measured congestion condition outside the parking lot but also the congestion condition inside the parking lot. For example, a basic fee of the parking lot is set to be higher as an internal condition of the parking lot, that is, the occupancy rate becomes higher.

For example, when the occupancy rate of the parking lot is less than 50%, 50% or more to less than 80%, or 80% or more, the basic fee of the parking lot may be 300 yen/hour, 500 yen/hour, or 700 yen/hour, respectively. Further, as described above, in consideration of a degree of congestion in the external vicinity of the parking lot, for example, when the degree of congestion is high, medium, or low, +100 yen/hour, 0 yen/hour, or −100 yen/hour can be added to the basic fee of the parking lot. These fees are merely examples, and may be set in any form.

In another example, for example, when the occupancy rate of the parking lot is less than 50%, 50% or more to less than 80%, 80% or more, the free parking period may be 2 hours, 1 hour, or 30 minutes, respectively. Further, as described above, in consideration of the degree of congestion in the external vicinity of the parking lot, for example, when the degree of congestion is high, medium, or low, −30 minutes, 0 minutes, or +30 minutes can be added to the free parking period. Note that these fees and times are merely examples, and can be set in any form.

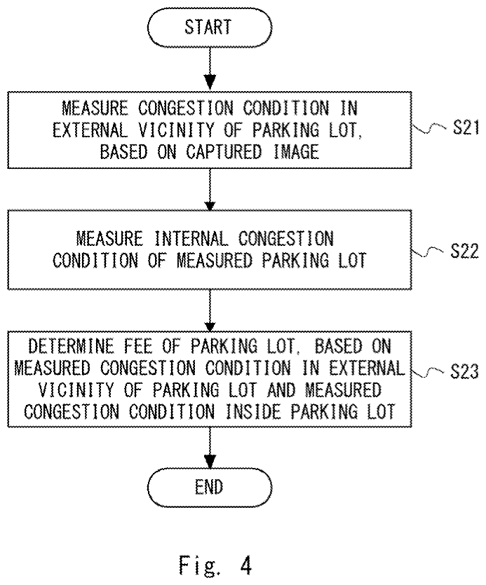

FIG. 4 is a flowchart illustrating a parking management method according to the second embodiment.

The external condition measuring unit 101 measures a congestion condition in an external vicinity of the parking lot, based on an image captured by the imaging unit (step S21). The internal condition measuring unit 102 measures a congestion condition inside the parking lot (step S22). The determining unit 103 determines a fee or a free parking period of the parking lot, based on the measured congestion condition in the external vicinity of the parking lot and the congestion condition inside the parking lot (step S23).

According to the second embodiment described above, it is possible to more appropriately determine the fee or the free parking period of the parking lot according to the congestion condition in the external vicinity of the parking lot and the congestion condition inside the parking lot.

### Third Example Embodiment

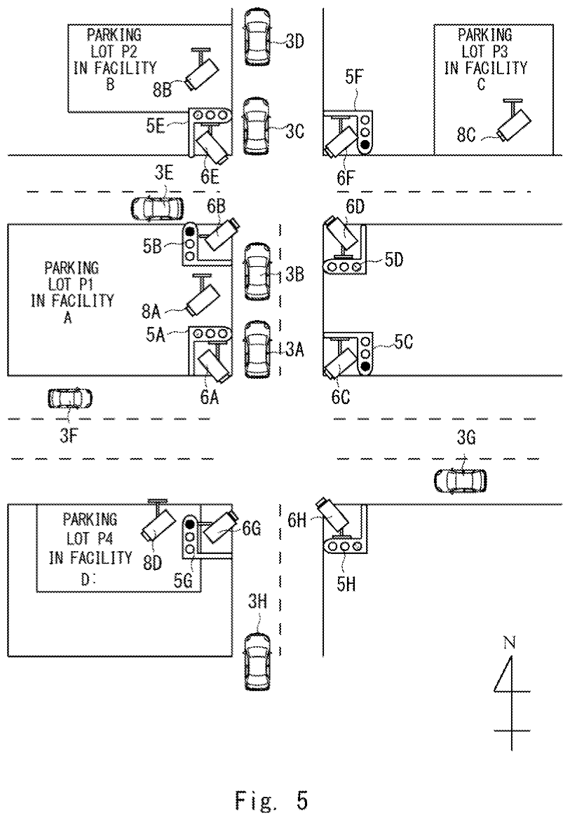

FIG. 5 is a diagram illustrating an exemplary overall configuration of a parking management system according to a third example embodiment. FIG. 5 illustrates a certain urban area viewed from above. The urban area includes a facility A having a parking lot P1, a facility B having a parking lot P2 located on a north side of the facility A with a road therebetween, a facility C having a parking lot P3 located on an east side of the facility B with a road therebetween, and a facility D having a parking lot P4 located on a south side of the facility A with a road therebetween. Imaging units 8A, 8B, 8C, and 8D are disposed on the facilities A, B, C, and D, respectively, and it is possible to recognize a usage state (occupancy rate, congestion condition) of the parking lot.

A user who drives a vehicle is navigated toward a destination registered by using an application on a portable terminal such as a smartphone or on an in-vehicle navigation system. The user can use service of presenting a location and a fee of a parking lot in a region and providing navigation to the parking lot, which is provided by a parking management system on the application on the portable terminal such as a smartphone or on the in-vehicle navigation system.

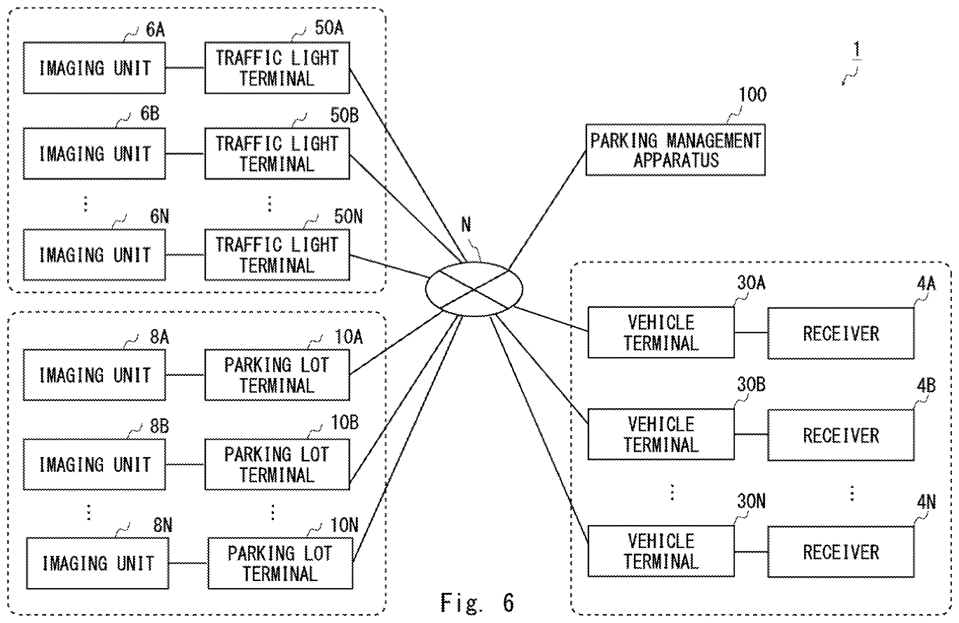

At each intersection, a traffic light 5 is disposed. Each of the traffic lights 5 includes a traffic light terminal (traffic light terminal 50 in FIG. 6) including a camera (or various sensors), a 5G (5th generation: fifth-generation mobile communication system) base station, a processor, and a memory. The traffic light terminal is achieved by a computer. The traffic light terminal is capable of relaying traffic lights and communicating with a vehicle or a portable terminal via a 5G network. Further, the traffic light terminal is capable of collecting surrounding area information (for example, a congestion condition) and the like by using the camera (or the various sensors). The surrounding area information also includes information on a vehicle, a pedestrian, and the like on a road. Although a 5G base station is exemplified as an example of the base station, the base station may be a long term evolution (LTE) base station or a base station of sixth-generation mobile communication system or later.

FIG. 6 is a block diagram illustrating a configuration of a parking management system 1 according to the third example embodiment.

A parking management apparatus 100 is connected to vehicle terminals 30A, 30B, . . . , 30N via a wired or wireless network. Further, the parking management apparatus 100 is connected to the traffic light terminals 50A, 50B, . . . , 50N and imaging units 6A, 6B, . . . , 6N connected thereto, via a wired or wireless network. The parking management apparatus 100 is connected to parking lot terminals 10A, 10B, . . . , 10N and the imaging units 8A, 8B, . . . , 8N connected thereto, via a wired or wireless network. The parking lot terminal 10 is a computer disposed in each parking lot, and is communicably connected to the parking management apparatus 100.

Note that, the vehicle terminal 30 can be achieved by a computer. The vehicle terminal 30 may include a receiver 4 for receiving a signal (e.g. a GPS signal) of a positioning system such as a global positioning system (GPS).

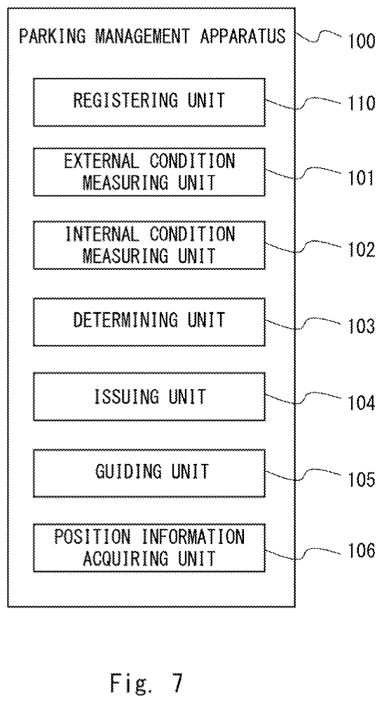

FIG. 7 is a block diagram illustrating a configuration of a parking management apparatus according to the third example embodiment.

The parking management apparatus 100 may be a server computer having a processor and memory. The parking management apparatus 100 may include a registering unit 110, an external condition measuring unit 101, an internal condition measuring unit 102, a determining unit 103, an issuing unit 104, a guiding unit 105, and a position information acquiring unit 106.

The registering unit 110 registers personal identification information of a user who uses the service. For example, when the service is used, an identification number (for example, a license plate, personal identification information) of a vehicle, a portable terminal, or the like of the user can be registered. Such registration may be performed by user input via a portable terminal or the like. The registration information may be stored in the parking management apparatus or in a storage unit connected thereto.

The external condition measuring unit 101 measures a congestion condition in a predetermined area (external surroundings) in a vicinity of the parking lot Pb. For example, in the example in FIG. 5, the imaging unit 6A of the traffic light 5A, the imaging unit 6B of the traffic light 5B, the imaging unit 6C of the traffic light 5C, the imaging unit 6D of the traffic light 5D, the imaging unit 6E of the traffic light 5E, the imaging unit 6F of the traffic light 5F, the imaging unit 6G of the traffic light 5G, and the imaging unit 6H of the traffic light 5H can be used as the external condition measuring unit 101. Based on the images captured by these imaging units, it is possible to measure the congestion condition of the predetermined area in the vicinity of the parking lot P1.

The external condition measuring unit 101 measures an external congestion condition between two adjacent parking lots. For example, the external condition measuring unit 101 measures a congestion condition of a road between the parking lot P1 and the parking lot P2. In another example embodiment, the external condition measuring unit 101 measures a congestion condition of a road between the parking lot P1 and the parking lot P4. In yet another example embodiment, the external condition measuring unit 101 measures a congestion condition of a road between the parking lot P1 and the parking lot P3.

The internal condition measuring unit 102 measures a congestion condition inside the parking lot, based on an image captured by the imaging unit 8A provided in the parking lot P1.

The determining unit 103 determines a fee or a free parking period of the parking lot, based on the measured congestion condition in the external vicinity of the parking lot P1 and the congestion condition inside the parking lot P1. Further, the determining unit 103 can relatively adjust fees of the parking lots in the entire area in consideration of not only an internal condition and an external condition of the parking lot P1 but also internal conditions and external conditions of the other parking lots P2, P3, and P4. Specifically, a fee may be adjusted in such a way as to achieve balance between the plurality of parking lots. For example, in a case in which the external vicinity of the parking lot P1 is congested, it is possible to eliminate congestion in the external vicinity of the parking lot P1 by setting a higher fee for the parking lot P1 compared to the other parking lots P2, P3, and P4. Specifically, according to congestion in the external vicinity of P1, the fee of the parking lot P1 may be increased, or the fee of the parking lot P1 may not be changed and the fees of the surrounding parking lots may be adjusted by, for example, lowering the fees of the other parking lots P2, P3, and P4. Further, the determining unit 103 may perform fee adjustment as described above, according to congestion inside the parking lots.

Further, as an example of adjusting the fee in such a way as to achieve balance between a plurality of parking lots, the determining unit 103 may determine the parking fee in such a way that an average parking fee per hour of the plurality of parking lots is constant. The determining unit 103 may change an average value of the parking fees per hour of the plurality of parking lots according to a time zone such as daytime and midnight, a weekday, a holiday, or the like, and adjust the parking fees of the plurality of parking lots in such a way as to be the average value. For example, in a case in which the parking lots are parking lots in an area where the parking lots are expected to be used on holidays, an average value of the parking fees on a holiday may be set to be higher than that on a weekday, and the parking fees of the plurality of parking lots may be adjusted in such a way as to have a set average value.

Although an example relates to adjustment of a parking fee has been described, the determining unit 103 can also determine a free parking period in a similar way as adjustment of a parking fee.

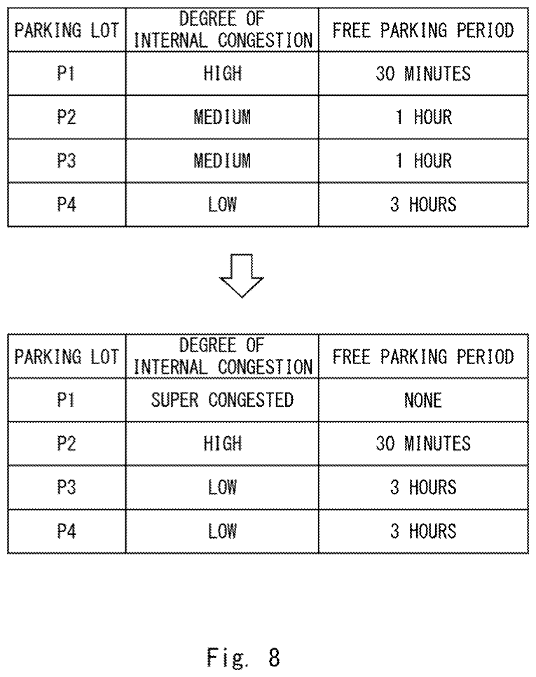

FIG. 8 illustrates an example of dynamic pricing of each of the parking lots.

For example, when a user starts an application of a smartphone, candidates for a nearby parking lot is automatically presented. After that, when the user selects a desired parking lot in consideration of a fee and a location of the parking lot, navigation is started on the application. Further, the application may be an application linked to a car navigation system.

As illustrated in FIG. 8, it is assumed that, at a certain point in time, a degree of internal congestion is “high” for the parking lot P1, “medium” for the parking lot P2, the “medium” for the parking lot P3, and “low” for the parking lot P2. In this case, the determining unit 103 may determine that the free parking period is 30 minutes, 1 hour, 1 hour, and 3 hours for the parking lots P1, P2, P3, and P4, respectively.

After that, it is assumed that, after a predetermined period of time has elapsed, the degree of internal congestion changes to “super congested” for the parking lot P1, “high” for the parking lot P2, “low” for the parking lot P3, and “low” for the parking lot P2. In this case, the determining unit 103 may dynamically determine that the free parking periods is none, 30 minutes, 3 hours, and 3 hours for the parking lots P1, P2, P3, and P4, respectively. These periods are merely examples, and can be set in any form.

The fee or the free parking period of each of these parking lots is presented to a user (i.e., the vehicle terminal 30 or a portable terminal) looking for a parking lot. The user can select and reserve a desired parking lot via the vehicle terminal 30 (for example, a car navigation system) or the portable terminal.

Referring back to FIG. 7, description of the components of the parking management apparatus 100 will be continued. When the vehicle registered in the registering unit 110 reaches a vicinity of a predetermined traffic light, the issuing unit 104 issues an electronic numbered ticket to a terminal in a vehicle 3. For example, when a vehicle 3H of a user who wants to park in the parking lot P1 is captured by the imaging unit 6G of the traffic light 5G, the issuing unit 104 issues an electronic numbered ticket to a terminal in the vehicle 3H in advance. In another example embodiment, a position information of a vehicle may be acquired and an electronic numbered ticket may be issued when the vehicle reaches a specific area.

In this way, the issuing unit 104 can issue an electronic numbered ticket to the terminal of one or more vehicles 3 in advance. In consideration of the number of issued electronic numbered tickets, the determination unit 103 may determine a current or future parking fee or free parking period.

Note that, types of the electronic numbered ticket may include a numbered ticket for a parking lot in any location, and a numbered ticket for a specific parking lot. Electronic tickets are issued in order for a vehicle that reaches a specific area or a specific traffic light, and the parking management apparatus can contact the vehicle when its turn has come. When the user parks the vehicle at the parking lot and the user instructs to end the parking navigation on the application, the parking management apparatus is notified of the instruction. Note that the determining unit 103 can determine the fee of the parking lot when issuing the numbered ticket. Thereafter, when there is a change in the parking fee, the parking management apparatus 100 may notify the user of the changed fee.

The issuing unit 104 can identify a license plate of a vehicle by using an image recognition technology and can issue an electronic numbering ticket to a terminal of the identified vehicle and a portable terminal associated with the vehicle. By issuing the electronic numbering ticket by using a captured image of the vehicle, it is possible to more accurately and precisely recognize the vehicle and issue an electronic numbered than in a case in which position information of GPS and the like is used.

The guiding unit 105 can perform navigation of a vehicle by using map information and position information of a subsequent vehicle or the like. As described above, when a user selects a desired parking lot, navigation to the parking lot can be performed.

The position information acquiring unit 106 acquires position information of a vehicle or a portable terminal in the vehicle by using various positioning systems.

In some example embodiments, all or a part of the functions of the parking management apparatus 100 may be included in the functions of the traffic light terminal 50, the vehicle terminal 30, or the parking lot terminal 10. The parking lot may separately have an entrance for a vehicle for which an electronic numbering ticket is issued and an entrance for a vehicle for which an electronic numbering ticket is not issued. The functions of the parking control apparatus 100 may be provided in a software as a service (SaaS) format.

According to the third example embodiment described above, it is possible to more appropriately determine the fee or the free parking period of the parking lot according to the congestion condition in the external vicinity of the parking lot, the congestion condition inside the parking lot, and the congestion condition of another neighboring parking lot. In addition, it is possible to more appropriately determine the fee or the free parking period of the parking lot according to an issuance status of an electronic numbered ticket.

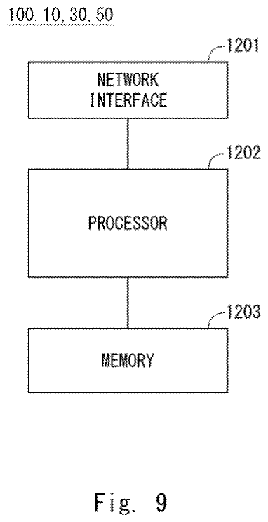

FIG. 9 is a block diagram illustrating a configuration example of hardware of the parking management apparatus 100, the parking lot terminal 10, the vehicle terminal 30, and the traffic light terminal 50 (hereinafter, referred to as a parking management apparatus 100 and the like). Referring to FIG. 9, the parking management apparatus 100 and the like include a network interface 1201, a processor 1202, and a memory 1203. The network interface 1201 is used for communicating with another network node apparatus constituting a communication system. The network interface 1201 may be used for performing wireless communication. For example, the network interface 1201 may be used for performing wireless-LAN communication defined in IEEE 802.11 series or mobile communication defined in 3rd generation partnership project (3GPP). Alternatively, the network interface 1201 may include a network interface card (NIC) compliant with IEEE 802.3 series, for example.

The processor 1202 reads software (computer program) from the memory 1203, executes the software, and thereby performs the processing in the parking management apparatus 100 and the like described using the flowchart or the sequence in the above-described example embodiment. The processor 1202 may be, for example, a microprocessor, micro processing unit (MPU), or central processing unit (CPU). The processor 1202 may include a plurality of processors.

The memory 1203 is constituted of a combination of a volatile memory and a non-volatile memory. The memory 1203 may include storage located remotely from the processor 1202. In this case, the processor 1202 may access the memory 1203 via an unillustrated I/O interface.

In the example in FIG. 9, the memory 1203 is used for storing a group of software modules. The processor 1202 read these software modules from the memory 1203, executes the software modules, and can thereby perform the processing in the parking management apparatus 100 described in the above-described example embodiment.

As described with reference to FIG. 2 or FIG. 4, each of the processors included in the parking management apparatus 100 executes one or more programs including a group of instructions for causing a computer to perform the algorithm described with reference to the drawings.

In the examples described above, the programs may be stored and provided to a computer using various types of non-transitory computer-readable medium. The non-transitory computer-readable medium includes various types of tangible storage medium. Examples of the non-transitory computer-readable medium include a magnetic recording medium (e.g., a flexible disk, a magnetic tape, a hard disk drive), a magneto-optical recording medium (e.g., a magneto-optical disk), a read only memory (CD-ROM), CD-R, CD-R/W, and a semi-conductor memory (e.g., a mask ROM, a programmable ROM (PROM), an erasable PROM (EPROM), a flash ROM, a random access memory (RAM)). The program may also be provided to the computer by using various types of transitory computer-readable medium. Examples of the transitory computer-readable medium include an electrical signal, an optical signal, and an electromagnetic wave. The transitory computer-readable medium can supply the program to the computer via a wired communication path such as an electric wire and an optical fiber, or a wireless communication path.

The present disclosure is not limited to the above-described example embodiments, and can be appropriately modified without departing from the scope of the present disclosure.

Some or all of the above-described example embodiments may be described as the following supplementary notes, but are not limited thereto.

### (Supplementary Note 1)

A parking management apparatus comprising:
an external condition measuring unit configured to measure a congestion condition in an external vicinity of a parking lot, based on an image acquired from an imaging unit; and
a determining unit configured to determine a fee or a free parking period of the parking lot, based on a measured congestion condition in the external vicinity of the parking lot.

### (Supplementary Note 2)

The parking management apparatus according to Supplementary note 1, further comprising an internal condition measuring unit configured to measure a congestion condition inside the parking lot,
wherein the determining unit determines a fee or a free parking period of the parking lot, based on a congestion condition in the external vicinity of the parking lot and a congestion condition inside the parking lot.

### (Supplementary Note 3)

The parking management apparatus according to Supplementary note 1 or 2, wherein
the external condition measuring unit measures external congestion conditions of a plurality of parking lots, and
the determining unit relatively adjusts fees or free parking periods of a plurality of parking lots, based on congestion conditions in an external vicinity of the plurality of parking lots.

### (Supplementary Note 4)

The parking management apparatus according to Supplementary note 1, wherein the determining unit determines a parking fee or a free parking period of the parking lot, based on a congestion condition in an external vicinity of another parking lot.

### (Supplementary Note 5)

The parking management apparatus according to Supplementary note 2, wherein the determining unit determines a parking fee or a free parking period of the parking lot, based on a congestion condition in an external vicinity of another parking lot and a congestion condition inside another parking lot.

### (Supplementary Note 6)

The parking management apparatus according to any one of Supplementary notes 1 to 5, further comprising an issuing unit configured to issue an electronic numbered ticket to a user who wants to park in the parking lot,
wherein the determining unit determines a fee or a free parking period of the parking lot, based on a congestion condition in the vicinity of the parking lot, a congestion condition inside the parking lot, and an issuance state of the electronic numbered ticket.

### (Supplementary Note 7)

The parking management apparatus according to any one of Supplementary notes 1 to 6, wherein the imaging unit in the external condition measuring unit is attached to a traffic light.

### (Supplementary Note 8)

The parking management apparatus according to Supplementary note 6, wherein the issuing unit issues an electronic numbered ticket when a vehicle of a user who wants to park in the parking lot is captured by an imaging unit of a specific traffic light.

### (Supplementary Note 9)

The parking management apparatus according to any one of Supplementary notes 1 to 8, further comprising a position information acquiring unit configured to acquire position information of a terminal in a vehicle.

### (Supplementary Note 10)

A parking management system comprising:
an external condition measuring unit configured to measure a congestion condition in an external vicinity of a parking lot, based on an image acquired from an imaging unit; and
a determining unit configured to determine a fee or a free parking period of the parking lot, based on a measured congestion condition in the external vicinity of the parking lot.

### (Supplementary Note 11)

The parking management system according to Supplementary note 10, further comprising an internal condition measuring unit configured to measure a congestion condition inside the parking lot,
wherein the determining unit determines a fee or a free parking period of the parking lot, based on a congestion condition in the external vicinity of the parking lot and a congestion condition inside the parking lot.

### (Supplementary Note 12)

The parking management system according to Supplementary note 10 or 11, wherein
the external condition measuring unit measures an external congestion condition between a plurality of parking lots, and
the determining unit relatively adjusts fees or free parking periods of a plurality of parking lots.

### (Supplementary Note 13)

The parking management system according to Supplementary note 10, wherein the determining unit determines a parking fee or a free parking period of the parking lot, based on a congestion condition in an external vicinity of another parking lot.

### (Supplementary Note 14)

The parking management system according to Supplementary note 11, wherein the determining unit determines a parking fee or a free parking period of the parking lot, based on a congestion condition in an external vicinity of another parking lot and a congestion condition inside another parking lot.

### (Supplementary Note 15)

The parking management system according to any one of Supplementary notes 10 to 14, further comprising an issuing unit configured to previously issue an electronic numbered ticket to a user who wants to park in the parking lot,
wherein the determining unit determines a fee or a free parking period of the parking lot, based on a congestion condition in the external vicinity of the parking lot, a congestion condition inside the parking lot, and an issuance state of the electronic numbered ticket.

### (Supplementary Note 16)

The parking management system according to any one of Supplementary notes 10 to 14, wherein the imaging unit in the external condition measuring unit is attached to a traffic light.

### (Supplementary Note 17)

The parking management system according to Supplementary note 15, wherein the issuing unit issues an electronic numbered ticket when a vehicle of a user who wants to park in the parking lot is captured by an imaging unit of a specific traffic light.

### (Supplementary Note 18)

The parking management system according to any one of Supplementary notes 10 to 17, further comprising a position information acquiring unit configured to acquire position information of a terminal in a vehicle.

### (Supplementary Note 19)

A parking management method comprising:
measuring a congestion condition in an external vicinity of a parking lot, based on a captured image acquired from an imaging unit; and
determining a fee or a free parking period of the parking lot, based on a measured congestion condition in the external vicinity of the parking lot.

### (Supplementary Note 20)

A non-transitory computer-readable medium storing a program configured to cause a computer to execute:
processing of measuring a congestion condition in an external vicinity of a parking lot, based on an image acquired from an imaging unit; and
processing of determining a fee or a free parking period of the parking lot, based on a measured congestion condition in the external vicinity of the parking lot.

### REFERENCE SIGNS LIST

1 PARKING MANAGEMENT SYSTEM
3 VEHICLE
5 TRAFFIC LIGHT
6 IMAGING UNIT
8 IMAGING UNIT
10 PARKING LOT TERMINAL
30 VEHICLE TERMINAL
50 TRAFFIC LIGHT TERMINAL
100 PARKING MANAGEMENT APPARATUS
110 REGISTERING UNIT
101 EXTERNAL CONDITION MEASURING UNIT
102 INTERNAL CONDITION MEASURING UNIT
103 DETERMINING UNIT
104 ISSUING UNIT
105 GUIDING UNIT
106 POSITION INFORMATION ACQUIRING UNIT

What is claimed is:

1. A parking management apparatus comprising:
at least one memory storing instructions, and
at least one processor configured to execute the instructions to;
measure a congestion condition in an external vicinity of a parking lot, based on an image acquired from an imaging unit; and
determine a fee or a free parking period of the parking lot, based on a measured congestion condition in the external vicinity of the parking lot.

2. The parking management apparatus according to claim 1, wherein the at least one processor configured to execute the instructions to;
measure a congestion condition inside the parking lot,
determine a fee or a free parking period of the parking lot, based on a congestion condition in the external vicinity of the parking lot and a congestion condition inside the parking lot.

3. The parking management apparatus according to claim 1, wherein the at least one processor configured to execute the instructions to;
measure external congestion conditions of a plurality of parking lots, and
relatively adjust fees or free parking periods of a plurality of parking lots, based on congestion conditions in an external vicinity of the plurality of parking lots.

4. The parking management apparatus according to claim 1, wherein the at least one processor configured to execute the instructions to;
determine a parking fee or a free parking period of the parking lot, based on a congestion condition in an external vicinity of another parking lot.

5. The parking management apparatus according to claim 2, wherein the at least one processor configured to execute the instructions to;
determine a parking fee or a free parking period of the parking lot, based on a congestion condition in an external vicinity of another parking lot and a congestion condition inside another parking lot.

6. The parking management apparatus according to claim 1, wherein the at least one processor configured to execute the instructions to; issue an electronic numbered ticket to a user who wants to park in the parking lot,
wherein the at least one processor configured to execute the instructions to; determine a fee or a free parking period of the parking lot, based on a congestion condition in the vicinity of the parking lot, a congestion condition inside the parking lot, and an issuance state of the electronic numbered ticket.

7. The parking management apparatus according to claim 1, wherein the imaging unit is attached to a traffic light.

8. The parking management apparatus according to claim 6, wherein the at least one processor configured to execute the instructions to; issue an electronic numbered ticket when a vehicle of a user who wants to park in the parking lot is captured by an imaging unit of a specific traffic light.

9. The parking management apparatus according to claim 1, wherein the at least one processor configured to execute the instructions to; acquire position information of a terminal in a vehicle.

10. A parking management system comprising:
at least one memory storing instructions, and
at least one processor configured to execute the instructions to;
measure a congestion condition in an external vicinity of a parking lot, based on an image acquired from an imaging unit; and
determine a fee or a free parking period of the parking lot, based on a measured congestion condition in the external vicinity of the parking lot.

11. The parking management system according to claim 10, wherein the at least one processor configured to execute the instructions to; measure a congestion condition inside the parking lot,
wherein the at least one processor configured to execute the instructions to; determine a fee or a free parking period of the parking lot, based on a congestion condition in the external vicinity of the parking lot and a congestion condition inside the parking lot.

12. The parking management system according to claim 10, wherein the at least one processor configured to execute the instructions to; measure an external congestion condition between a plurality of parking lots, and
relatively adjust fees or free parking periods of a plurality of parking lots.

13. The parking management system according to claim 10, wherein the at least one processor configured to execute the instructions to; determine a parking fee or a free parking period of the parking lot, based on a congestion condition in an external vicinity of another parking lot.

14. The parking management system according to claim 11, wherein the at least one processor configured to execute the instructions to; determine a parking fee or a free parking period of the parking lot, based on a congestion condition in an external vicinity of another parking lot and a congestion condition inside another parking lot.

15. The parking management system according to claim 10, wherein the at least one processor configured to execute the instructions to; previously issue an electronic numbered ticket to a user who wants to park in the parking lot,
wherein the at least one processor configured to execute the instructions to; determine a fee or a free parking period of the parking lot, based on a congestion condition in the external vicinity of the parking lot, a congestion condition inside the parking lot, and an issuance state of the electronic numbered ticket.

16. The parking management system according to claim 10, wherein the imaging unit is attached to a traffic light.

17. The parking management system according to claim 15, wherein the at least one processor configured to execute the instructions to; issue an electronic numbered ticket when a vehicle of a user who wants to park in the parking lot is captured by an imaging unit of a specific traffic light.

18. The parking management system according to claim 10, wherein the at least one processor configured to execute the instructions to; acquire position information of a terminal in a vehicle.

19. A parking management method comprising:
measuring a congestion condition in an external vicinity of a parking lot, based on a captured image acquired from an imaging unit; and
determining a fee or a free parking period of the parking lot, based on a measured congestion condition in the external vicinity of the parking lot.

20. The parking management method according to claim 19, further comprising:
measuring external congestion conditions of a plurality of parking lots, and
relatively adjusting fees or free parking periods of a plurality of parking lots, based on congestion conditions in an external vicinity of the plurality of parking lots.
